(19) United States
(12) Patent Application Publication
(10) Pub. No.: US 2014/0027004 A1
(43) Pub. Date: Jan. 30, 2014

(54) PRINTING STRUCTURE OF A WATER PIPE

(71) Applicant: Wen-Li KUO, Changhua County (TW)

(72) Inventor: Wen-Li KUO, Changhua County (TW)

(21) Appl. No.: 13/559,627

(22) Filed: Jul. 27, 2012

(51) Int. Cl. F16L 11/04

(52) U.S. Cl. 138/145

(57) ABSTRACT

A printing structure of a water pipe contains a body having a plastic layer formed around an outer rim of the body and a printing layer integrally formed with and around the plastic layer, wherein the printing layer has a color pattern or a graphic pattern transfer printed thereon. The printing water pipe has a variety of patterns on the body thereof so as to provide pattern options to the customer. In addition, the pattern on the body of the water pipe allows being printed based on the users' requirement, thus obtaining customization.

### FIELD OF THE INVENTION

The present invention relates to a water pipe, and more particularly to a printing structure of the water pipe which has a printing layer to enhance aesthetics appearance.

### BACKGROUND OF THE INVENTION

As shown in FIGS. 1 and 2; a conventional water pipe 10 contains a plastic layer 11 with a single color. However, such a conventional water pipe has a bored single color and appearance, so it can not satisfy user's visual requirement.

Furthermore, when turning the car at a corner of a road, the driver can not have enough light to see the driving circumstance clearly, thus causing the danger as well.

The present invention has arisen to mitigate and/or obviate the afore-described disadvantages.

### SUMMARY OF THE INVENTION

The primary object of the present invention is to provide a printing structure of a water pipe which has a printing layer integrally formed with and around the water pipe, wherein the printing layer has a color pattern or a graphic pattern transfer printed thereon so that the water pipe and the printing layer are integrally formed together.

Another object of the present invention is to provide a printing structure of a water pipe in which the pattern on the body of the printing structure allows being printed based on the users' requirement, thus obtaining customization.

To obtain the above objectives, printing structure of a water pipe contains:

a body having a plastic layer formed around an outer rim of the body and a printing layer integrally formed with and around the plastic layer;

wherein the printing layer has a pattern formed thereon by selecting from a color pattern and a graphic pattern;

wherein the pattern of the printing layer is transfer printed on the printing layer.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional water pipe.

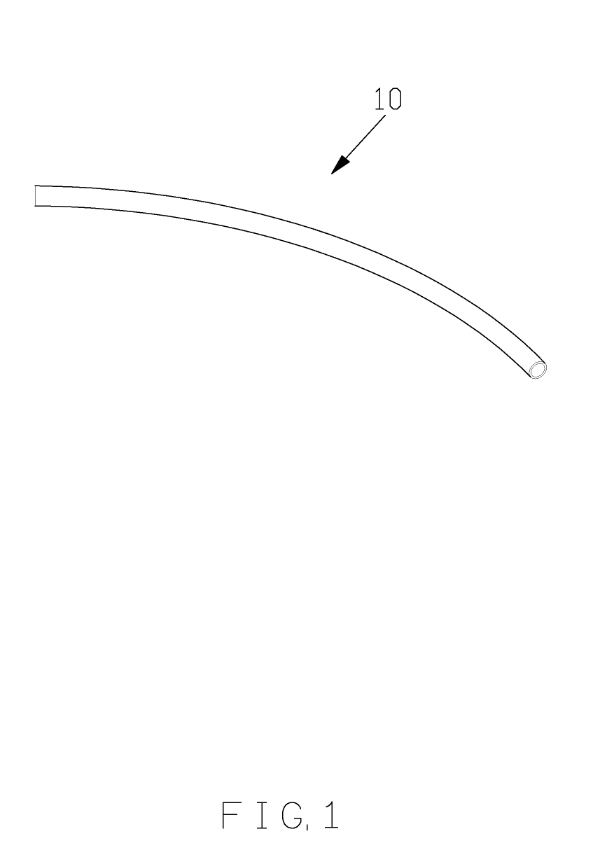

FIG. 2 is a cross sectional view of the conventional water pipe.

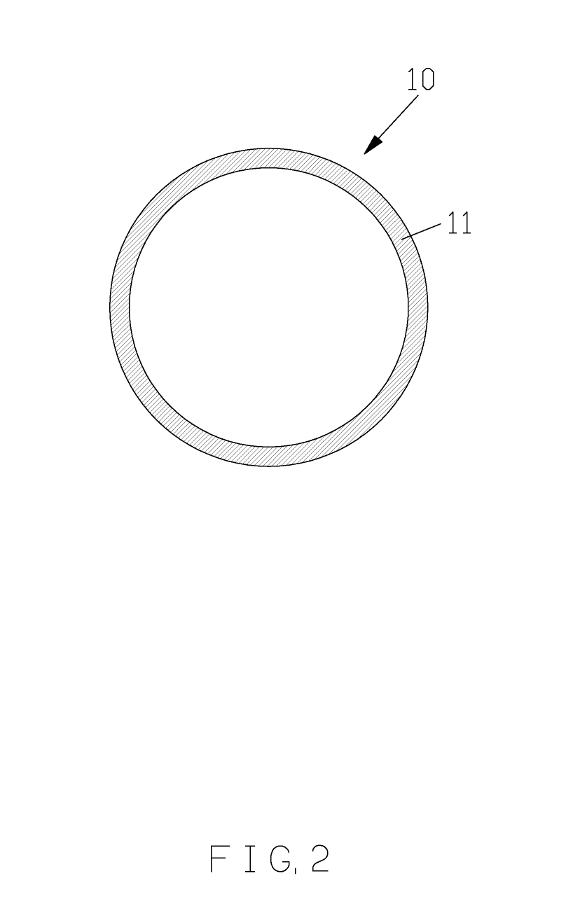

FIG. 3 is a perspective view showing the assembly of a printing structure of a water pipe according to a preferred embodiment of the present invention.

FIG. 4 is a cross sectional view showing the assembly of the printing structure of the water pipe according to the preferred embodiment of the present invention.

FIG. 5 is a plan view showing the applications of the printing structure of the water pipe according to the preferred embodiment of the present invention.

### DETAILED DESCRIPTION OF THE PREFERRED EMBODIMENTS

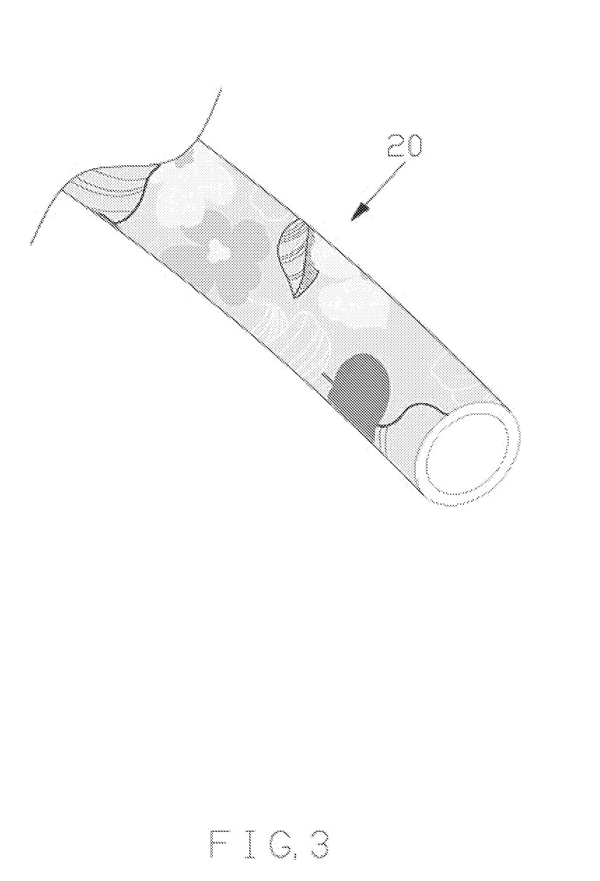

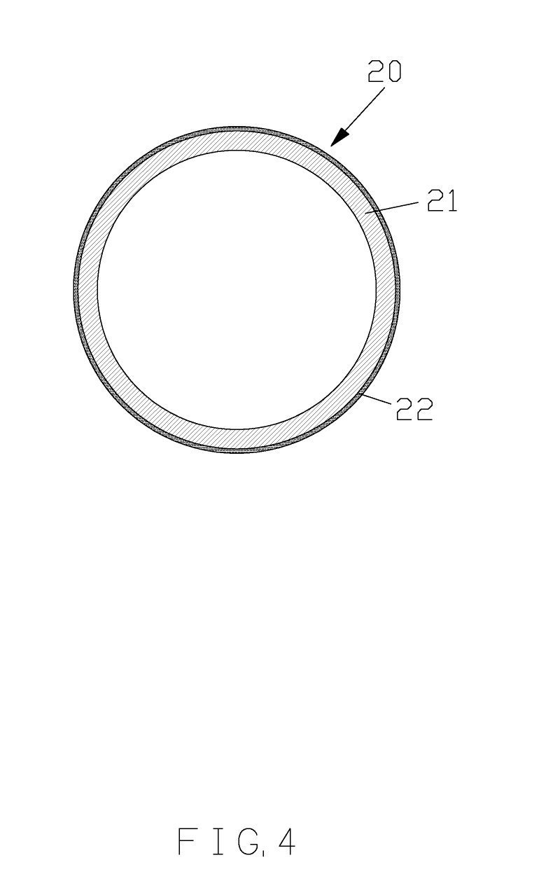

Referring to FIGS. 3 and 4, a printing structure of a water pipe according to a preferred embodiment of the present invention comprises a body 20 having a plastic layer 21 formed around an outer rim of the body 20 and a printing layer 22 integrally formed with and around the plastic layer 21, wherein the printing layer 22 has a color pattern or a graphic pattern transfer printed thereon.

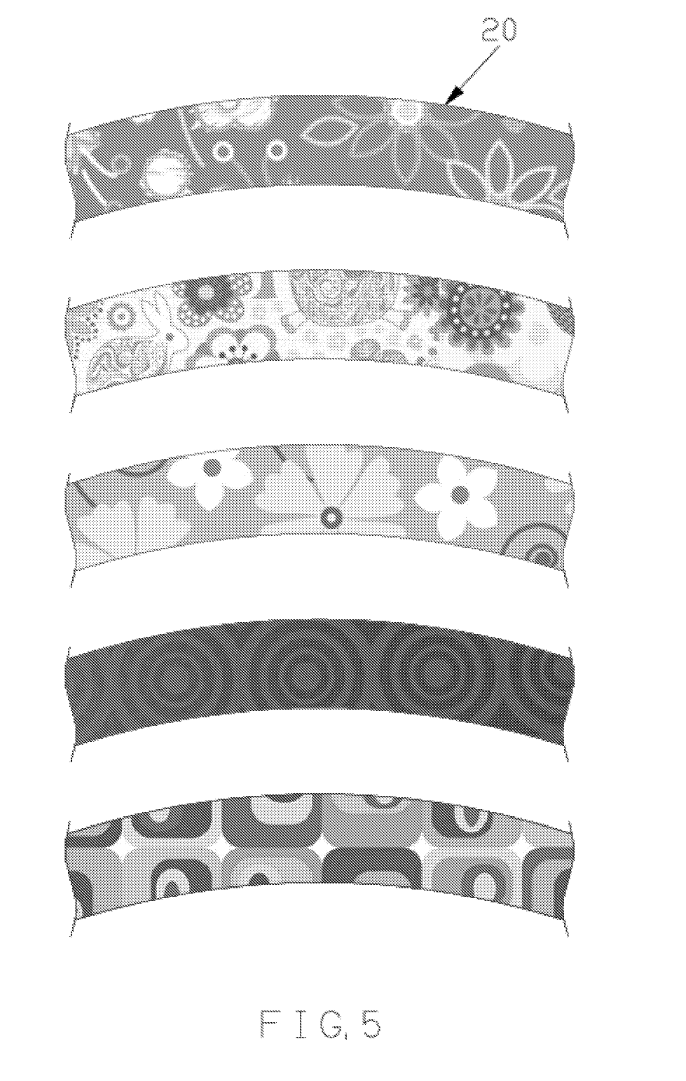

Referring further to FIG. 5, the printing structure of the water pipe has a variety of patterns on the body 20 thereof so as to provide pattern options to the customer. In addition, the pattern on the body 20 of the printing structure allows being printed based on the users' requirement, thus obtaining customization.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A printing structure of a water pipe comprising:
a body having a plastic layer formed around an outer rim of the body and a printing layer integrally formed with and around the plastic layer;
wherein the printing layer has a pattern formed thereon by selecting from a color pattern and a graphic pattern;
wherein the pattern of the printing layer is transfer printed on the printing layer.

2. The printing structure of the water pipe as claimed in claim 1, wherein the pattern of the printing layer is printed based on a user's requirement.
